(19) United States
(12) Patent Application Publication
(10) Pub. No.: US 2025/0345749 A1
(43) Pub. Date: Nov. 13, 2025

(54) TRANSIENT OPERATION METHOD FOR SEPARATION DEVICE

(71) Applicant: NGK INSULATORS, LTD., Nagoya-City (JP)

(72) Inventors: Miyuki KOJIMA, Nagoya-Shi (JP); Katsuya SHIMIZU, Owariasahi-Shi (JP); Kazuki IIDA, Nagoya-Shi (JP); Kosuke NAKAGAWA, Nagoya-Shi (JP); Sota MAEHARA, Nagoya-Shi (JP); Hirofumi KAN, Nagoya-Shi (JP)

(73) Assignee: NGK INSULATORS, LTD., Nagoya-City (JP)

(21) Appl. No.: 19/277,605

(22) Filed: Jul. 23, 2025

Related U.S. Application Data
(63) Continuation of application No. PCT/JP2024/003108, filed on Jan. 31, 2024.

(30) Foreign Application Priority Data
Feb. 3, 2023 (JP) 2023-015658

(51) Int. Cl. B01D 61/36; B01D 71/02

(52) U.S. Cl. CPC B01D 61/36; B01D 71/0281; B01D 2323/081

(57) ABSTRACT

A transient operation method for a separation device includes a separation membrane complex including: a separation membrane; and a substrate arranged on one side of the separation membrane, the separation device having a first flow path and a second flow path, the first flow path being positioned on a side closer to the separation membrane of the separation membrane complex, the second flow path being positioned on a side closer to the substrate of the separation membrane complex, the transient operation method including heating the separation membrane complex by supplying a gas at least to the second flow path. The gas supplied to the second flow path satisfies the specific formula.

### CROSS-REFERENCE TO RELATED APPLICATIONS

This application is a continuation under 35 U.S.C. 120 of International Application PCT/JP2024/003108 having the International Filing Date of Jan. 31, 2024, and having the benefit of the earlier filing date of Japanese Application No. 2023-015658 filed on Feb. 3, 2023. Each of the identified applications is fully incorporated herein by reference.

### BACKGROUND OF THE INVENTION

### 1. Field of the Invention

One or more embodiments of the present disclosure relates to a transient operation method for a separation device.

### 2. Description of the Related Art

There has been known a membrane separation method that uses a separation membrane to separate a specific substance from a mixture. As such a membrane separation method, a separation method using, for example, a zeolite membrane has been proposed (see Non Patent Literature 1). A separation device including a separation membrane sometimes requires heating of the separation membrane at the time of activation of the device so that the separation membrane can fulfill a predetermined function. In this case, it is required that efficient heating throughout the separation membrane be performed.

### CITATION LIST

### Non Patent Literature

[NPL 1] Development of Membrane Aided Reactor, Mitsui Zosen Technical Review, February 2003, No. 178, 115-120

### SUMMARY OF THE INVENTION

A primary object of the present disclosure is to provide a transient operation method for a separation device including a separation membrane, which enables efficient heating of the separation membrane.

[1] According to an embodiment of the present disclosure, there is provided a transient operation method for a separation device, the separation device including a separation membrane complex including: a separation membrane; and a substrate arranged on one side of the separation membrane, the separation device having a first flow path and a second flow path, the first flow path being positioned on a side closer to the separation membrane of the separation membrane complex, the second flow path being positioned on a side closer to the substrate of the separation membrane complex, the transient operation method including heating the separation membrane complex by supplying a gas at least to the second flow path. The gas supplied to the second flow path satisfies the following formula (1):

$$Δ {Cp}_{2} / Δ {T}_{2} < 0 ( J / ( mol \cdot {K}^{2} ) ) \qquad ( 1 )$$

where ΔCp₂ represents a difference between a molar specific heat at constant pressure “a” at the separation membrane complex inlet of the second flow path and a molar specific heat at constant pressure “b” at the separation membrane complex outlet of the second flow path (molar specific heat at constant pressure “a”-molar specific heat at constant pressure “b”) (in J/(mol ·K) as unit), and

ΔT₂ represents a difference between a gas temperature “a” at the separation membrane complex inlet of the second flow path and a gas temperature “b” at the separation membrane complex outlet of the second flow path (gas temperature “a”-gas temperature “b”) (in K as unit).

According to an embodiment of the present disclosure, there is provided a transient operation method for a separation device, the separation device including a separation membrane complex including: a separation membrane; and a substrate arranged on one side of the separation membrane, the separation device having a first flow path and a second flow path, the first flow path being positioned on a side closer to the separation membrane of the separation membrane complex, the second flow path being positioned on a side closer to the substrate of the separation membrane complex, the transient operation method including: heating the separation membrane complex by supplying gases to the first flow path and the second flow path, respectively, wherein ΔCp₂/ΔT₂ of the gas supplied to the second flow path is smaller than ΔCp₁/ΔT₁ of the gas supplied to the first flow path. The ΔCp₁ represents a difference between a molar specific heat at constant pressure “c” at the separation membrane complex inlet of the first flow path and a molar specific heat at constant pressure “d” at the separation membrane complex outlet of the first flow path (molar specific heat at constant pressure “c”-molar specific heat at constant pressure “d”) (in J/(mol ·K) as unit). The ΔT₁ represents a difference between a gas temperature “c” at the separation membrane complex inlet of the first flow path and a gas temperature “d” at the separation membrane complex outlet of the first flow path (gas temperature “c”-gas temperature “d”) (in K as unit). The ΔCp₂ represents a difference between a molar specific heat at constant pressure “a” at the separation membrane complex inlet of the second flow path and a molar specific heat at constant pressure “b” at the separation membrane complex outlet of the second flow path (molar specific heat at constant pressure “a”-molar specific heat at constant pressure “b”) (in J/(mol ·K) as unit). The ΔT₂ represents a difference between a gas temperature “a” at the separation membrane complex inlet of the second flow path and a gas temperature “b” at the separation membrane complex outlet of the second flow path (gas temperature “a”-gas temperature “b”) (in K as unit).

[3] In the transient operation method for a separation device according to the above-mentioned item [2], the gas supplied to the second flow path may satisfy the above-mentioned formula (1).

[4] In the transient operation method for a separation device according to any one of the above-mentioned items [1] to [3], the gas supplied to the second flow path may contain water vapor.

[5] In the transient operation method for a separation device according to the above-mentioned item [4], a water vapor content of the gas supplied to the second flow path may be 10 mol % or more.

[6] to [8] In the transient operation method for a separation device according to any one of the above-mentioned items [1] to [5], the gas temperature at the separation membrane complex inlet of the second flow path may be 100° C. or higher.

[9] In the transient operation method for a separation device according to any one of the above-mentioned items [1] to [6], the separation membrane may be a zeolite membrane.

[10] In the transient operation method for a separation device according to the above-mentioned item [9], the zeolite membrane may be made of LTA-type zeolite.

[11] The transient operation method according to any one of the above-mentioned items [1] to [10] may be an activation method.

[12] The transient operation method for a separation device according to any one of the above-mentioned items [1] to [10] may be a stopping method.

According to the embodiment of the present disclosure, the transient operation method for a separation device including a separation membrane, which enables efficient heating of the separation membrane, can be provided.

### BRIEF DESCRIPTION OF THE DRAWINGS

FIG. 1 is a schematic configuration view of a separation membrane complex to be used in a transient operation method for a separation device according to one embodiment of the present disclosure.

FIG. 2 is a schematic configuration view of a separation membrane and a substrate of FIG. 1.

FIG. 3 is a schematic configuration view of one modification example of the separation membrane complex.

FIG. 4 is a schematic cross-sectional view of the separation membrane complex of FIG. 3.

FIG. 5 is a schematic configuration view of another modification example of the separation membrane complex.

FIG. 6 is an explanatory schematic diagram for illustrating how a separation device is operated according to one embodiment of the present disclosure.

### DESCRIPTION OF THE EMBODIMENTS

Embodiments of the present disclosure are described below with reference to the drawings, but the present disclosure is not limited to those embodiments. For clearer illustration, some widths, thicknesses, shapes, and the like of respective portions may be schematically illustrated in the drawings in comparison to the embodiments. However, the widths, the thicknesses, the shapes, and the like are merely an example, and do not limit understanding of the present disclosure.

### A. Transient Operation Method for Separation Device

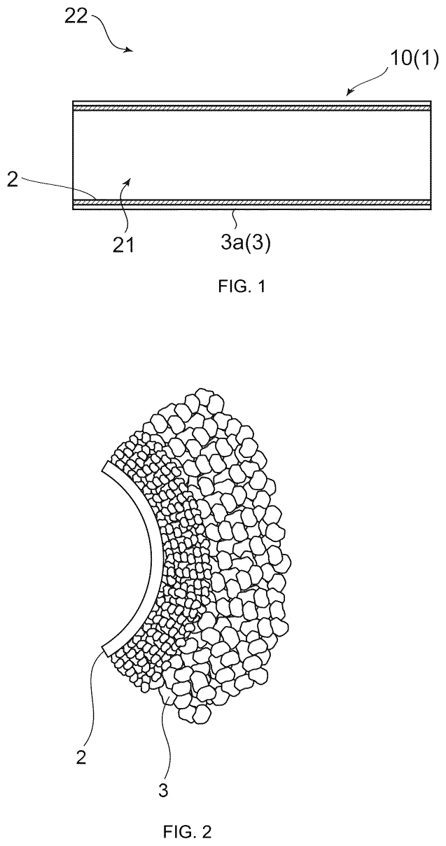

FIG. 1 is a schematic configuration view of a separation membrane complex to be used in a transient operation method for a separation device according to one embodiment of the present disclosure, and FIG. 2 is a schematic configuration view of a separation membrane and a substrate of FIG. 1.

The transient operation method for a separation device according to one embodiment of the present disclosure is a transient operation method for a separation device 1 including a separation membrane complex 10. The separation membrane complex 10 includes: a separation membrane 2; and a substrate 3 arranged on one side of the separation membrane 2. The separation device 1 has a first flow path 21 and a second flow path 22. The first flow path 21 is positioned on a side closer to the separation membrane 2 of the separation membrane complex 10. More specifically, the first flow path 21 can be positioned closer to the separation membrane 2 of the separation membrane complex 10 than to the substrate 3. Further, another element (not shown) may be present or absent between the separation membrane 2 and the first flow path 21. The second flow path 22 is positioned on a side closer to the substrate 3 of the separation membrane complex 10. More specifically, the second flow path 22 can be positioned closer to the substrate 3 of the separation membrane complex 10 than to the separation membrane 2. Further, another element (not shown) may be present or absent between the substrate 3 and the second flow path 22. Although not shown, the separation membrane complex 10 may include any appropriate other elements as long as the effects of the present disclosure are obtained. The separation membrane complex 10 may include, for example, a layer or powder, which protects the whole or part of the separation membrane 2, an element having a separation function, such as another separation membrane, and another substrate (for example, a layer that is thinner than the substrate 3 and has the same composition as that of the substrate 3) arranged on the opposite side of the separation membrane 2 to the substrate 3. Further, the substrate 3 may be partially exposed.

The transient operation method for the separation device 1 includes changing the temperature of (that is, heating or decreasing the temperature of) the separation membrane complex 10 by supplying a gas at least to the second flow path 22. An embodiment in which the separation membrane complex 10 is heated is described below as a typical example. Further, the separation membrane complex 10 may be heated by supplying a gas to the first flow path 21.

In one embodiment, after the separation device 1 is activated using the above-mentioned transient operation method, heating is continued until the separation membrane reaches a predetermined temperature (for example, a temperature that allows the separation membrane to fulfill a separation function). Then, the separation device starts a steady operation. During the steady operation, a fluid containing a substance that permeates through the separation membrane 2 (for example, a mixture containing water, which corresponds to a permeable substance, and a less permeable organic compound) is supplied to the first flow path 21. A substance that has permeated through the separation membrane 2 flows through the second flow path 22. Heating the separation membrane complex 10 by the transient operation method allows the separation membrane 2 to demonstrate predetermined separation performance (for example, separation performance based on permeability) during the steady operation.

In one embodiment, the gas supplied to the second flow path 22 satisfies the following formula (1):

$$Δ {Cp}_{2} / Δ {T}_{2} < 0 ( J / ( mol \cdot {K}^{2} ) ) \qquad ( 1 )$$

where ΔCp₂ represents a difference between a molar specific heat at constant pressure “a” at the separation membrane complex inlet of the second flow path and a molar specific heat at constant pressure “b” at the separation membrane complex outlet of the second flow path (molar specific heat at constant pressure “a”-molar specific heat at constant pressure “b”) (in J/(mol·K) as unit), and

ΔT₂ represents a difference between a gas temperature “a” at the separation membrane complex inlet of the second flow path and a gas temperature “b” at the separation membrane complex outlet of the second flow path (gas temperature “a”-gas temperature “b”) (in K as unit).

The value of ΔCp₂/ΔT₂ is more preferably smaller than −0.004,still more preferably smaller than −0.007. The lower limit of ΔCp₂/ΔT₂ is, for example, −0.1.

In the embodiment of the present disclosure, the separation membrane complex can be efficiently heated by setting ΔCp₂/ΔT₂ (also referred to as “temperature-difference specific heat coefficient”) to fall within the above-mentioned ranges. More specifically, it is assumed that heat transfer from a gas is more likely to occur on the upstream side of the separation membrane complex and heating is less likely to be achieved on the downstream side in the initial stage of heating. In the embodiment of the present disclosure, however, a temperature decrease of the gas, which may be caused along with its flow, is suppressed. Thus, efficient heating throughout the separation membrane complex can be performed. In the related art, a method of promoting heating on the downstream side by increasing the flow rate of a heating gas may be adopted. In this case, a blower and a heating device, which are peripheral equipment, are required to be increased in size, and hence an increase in energy consumption becomes an issue. According to the embodiment of the present disclosure, the separation membrane complex can be efficiently heated as described above while the flow rate of a heating gas is reduced. In other words, a major achievement of the embodiment of the present disclosure lies in having found that not a temperature-difference heat capacity coefficient (in W/K² as unit), which is calculated by multiplying a temperature-difference specific heat coefficient by a gas flow rate, but the temperature-difference specific heat coefficient is an important factor, in the examination of heat exchange between the heating gas and a body to be heated. The value of ΔT₂ is affected by the flow rate of the heating gas (ΔT₂ becomes smaller at a higher flow rate). Meanwhile, in the embodiment of the present disclosure, the separation membrane complex can be appropriately and efficiently heated irrelevantly of the gas flow rate by specifying the heating gas based on characteristic values including ΔT₂ and controlling the characteristic values.

In another embodiment, ΔCp₂/ΔT₂ of the gas supplied to the second flow path is smaller than ΔCp₁/ΔT₁ of the gas supplied to the first flow path. Also in this embodiment, ΔCp₂/ΔT₂ can be set to fall within the above-mentioned range (preferably smaller than 0, more preferably smaller than −0.004, still more preferably smaller than −0.007).

The ΔCp₁ represents a difference between a molar specific heat at constant pressure “c” at the separation membrane complex inlet of the first flow path and a molar specific heat at constant pressure “d” at the separation membrane complex outlet of the first flow path (molar specific heat at constant pressure “c”-molar specific heat at constant pressure “d”) (in J/(mol·K) as unit), and the ΔT₁ represents a difference between a gas temperature “c” at the separation membrane complex inlet of the first flow path and a gas temperature “d” at the separation membrane complex outlet of the first flow path (gas temperature “c”-gas temperature “d”) (in K as unit). As described above, the molar specific heat at constant pressure is a molar specific heat at constant pressure when the constant pressure is atmospheric pressure and the gas has the gas temperature at the corresponding position.

In the separation membrane complex including the substrate and the separation membrane, the substrate 3 is generally formed so as to have a higher heat capacity than that of the separation membrane 2. Thus, when ΔCp₁/ΔT₁ and ΔCp₂/ΔT₂ are specified as described above, the separation membrane complex 10 (substantially, the separation membrane 2) can be efficiently heated.

The value of ΔCp₁/ΔT₁ of the gas supplied to the first flow path is, for example, from 0 (J/(mol·K²)) to 0.06 (J/(mol·K²)).

In one embodiment, the gas temperature at the separation membrane complex inlet of the second flow path is 100° C. or higher. The gas temperature at the separation membrane complex inlet of the second flow path is preferably from 100° C. to 300° C., more preferably from 130° C. to 260° C. When the gas temperature falls within such ranges, the above-mentioned effect becomes pronounced. Further, also in the case of heating at a higher temperature, the transient operation method of the present disclosure can be preferably used when the gas temperature falls within the above-mentioned ranges. It is apparent that a gas containing water vapor may be continuously used for heating at a temperature exceeding the above-mentioned ranges. The gas temperature at the separation membrane complex inlet of the first flow path is, for example, from 100° C. to 300° C.

In one embodiment, the gas supplied to the second flow path contains water vapor. The temperature-difference specific heat coefficient can be controlled by a water vapor content. In one embodiment, the gas is supplied to the second flow path under conditions under which condensation does not form on or in the separation membrane complex.

In one embodiment, the water vapor content of the gas supplied to the first flow path is less than the water vapor content of the gas supplied to the second flow path. The separation membrane complex can be efficiently heated (for example, heating in the latter stage can be efficiently performed) by using a high-humidity gas as the gas supplied to the second flow path.

In one embodiment, the gas is supplied to the first flow path under conditions under which condensation does not form on or in the separation membrane complex.

The water vapor content of the gas supplied to the second flow path is preferably 10 mol % or more, more preferably 20 mol % or more. When the water vapor content falls within such ranges, the efficiency of heating of the separation membrane is remarkably increased. Further, the upper limit of the water vapor content of the gas supplied to the second flow path is, for example, 100 mol %. In one embodiment, when a water vapor partial pressure P(H₂O) and a saturation water vapor pressure P^{sat}(H₂O) of the gas supplied to the second flow path have a relationship of [P(H₂O)/P^{sat}(H₂O)<1], the water vapor content of the gas supplied to the second flow path falls within the above-mentioned ranges.

In one embodiment, the pressure of the first flow path 21 and/or the second flow path 22 is adjusted in accordance with the temperature of the environment under which the separation membrane complex 10 (substantially, the separation membrane 2) is placed. In the transient operation method for a separation device, the initial temperature of the separation membrane 2 is, for example, from 0° C. to 35° C., and an initial pressure in the first flow path 21 is, for example, from 0.1 MPaG to 20 MPaG. Further, at the time of completing the activation of the separation device, the temperature of the separation membrane 2 is, for example, from 100° C. to 350° C., and the pressure in the first flow path 21 is, for example, from 0.1 MPaG to 20 MPaG.

Herein, the term “transient operation method” refers to a concept including an activation method and a stopping method. Thus, in the description above of the embodiment, the “transient operation method” may be an “activation method” (that is, the “transient operation method” may be replaced by an “activation method”) or may be a “stopping method”. Herein, the “activation method” involves heating of the separation membrane. Further, the “stopping method” involves decreasing the temperature of the separation membrane.

### B. Separation Device

### B-1. Separation Membrane Complex

As illustrated in FIG. 1, the separation device 1 typically includes the separation membrane complex 10 including: the substrate 3; and the separation membrane 2. Although not shown, the separation membrane complex 10 is housed in any appropriate case for use. The separation membrane complex 10 typically extends in the same direction as the direction in which the first flow path 21 extends. The length of the separation membrane complex 10 may be appropriately and suitably adjusted. In the separation membrane complex, the weight ratio of the substrate 3 and the separation membrane 2 (substrate/separation membrane) is, for example, from 100 to 200,000. Further, the heat capacity ratio of the substrate 3 and the separation membrane 2 (substrate/separation membrane) is, for example, from 50 to 300,000.

### B-1-1. Substrate

The substrate 3 supports the separation membrane 2. In one embodiment, the substrate 3 is a porous substrate. The porous substrate has, for example, a so-called monolith-type structure including: a framework being continuous in a three-dimensional network pattern; and communication holes defined by the framework. The substrate 3 may contain a component for forming the separation membrane 2.

The specific heat of a material for forming the substrate is, for example, from 450 J/kgK to 1,100 J/kgK.

The porous substrate may be formed of any appropriate material. Typical examples of a material for the porous substrate include a ceramic sintered compact. Examples of the ceramic sintered compact include alumina, silica, mullite, zirconia, titania, yttria, silicon nitride, silicon carbide, and cordierite. The ceramic sintered compacts can be used alone or in combination.

The porous substrate may contain an inorganic binding material. Examples of the inorganic binding material include titania, mullite, easily sinterable alumina, silica, glass frit, clay mineral, and easily sinterable cordierite. The inorganic binding materials can be used alone or in combination.

The porous substrate may be made up of a single layer or may have a multilayer structure in which multiple layers are stacked. In one embodiment, as illustrated in FIG. 2, the porous substrate has a multilayer structure including a plurality of layers being different in pore diameter. In this case, it is preferred that the pore diameter of the layer closer to the separation membrane 2 be smaller.

The average pore diameter of the porous substrate is, for example, from 0.01 μm to 70 μm, preferably from 0.05 μm to 25 μm. The average pore diameter of the porous substrate on the separation membrane side is from 0.01 μm to 1 μm, preferably from 0.05 μm to 0.5 μm. With regard to the distribution of the pore diameters in the whole including the surface and inside of the porous substrate, D5 is, for example, from 0.01 μm to 50 μm, D50 is, for example, from 0.05 μm to 70 μm, and D95 is, for example, from 0.1 μm to 2, 000 μm. The porosity of the porous substrate on the separation membrane side is, for example, from 25% to 50%. The average pore diameter of the porous substrate may be measured with, for example, a mercury porosimeter, a perm porometer, or a nano-perm porometer.

As illustrated in FIG. 1, the substrate 3 typically separates the first flow path 21 and the second flow path 22 from each other. The substrate 3 may have any appropriate shape. Examples of the shape of the substrate 3 include a cylindrical shape, a honeycomb shape, and a plate-like shape.

In one embodiment, the substrate 3 is a cylindrical substrate 3a. Examples of the sectional shape of the cylindrical substrate 3a in the direction orthogonal to the length direction of the cylindrical substrate 3a include a triangular shape, a rectangular shape, a pentagonal shape, a polygonal shape having six or more sides, a circular shape, and an elliptical shape, and a preferred one is a circular shape. The outer diameter and the length of the cylindrical substrate may be appropriately set in accordance with its purpose.

In this embodiment, the internal space of the cylindrical substrate 3a (space defined by the inner peripheral surface of the cylindrical substrate) includes any one of the first flow path 21 or the second flow path 22, and the external space of the cylindrical substrate 3a (space outside the outer peripheral surface of the cylindrical substrate) includes another one of the first flow path 21 or the second flow path 22. In the illustrated example, the internal space of the cylindrical substrate 3a includes the first flow path 21, and the external space of the cylindrical substrate 3a includes the second flow path 22.

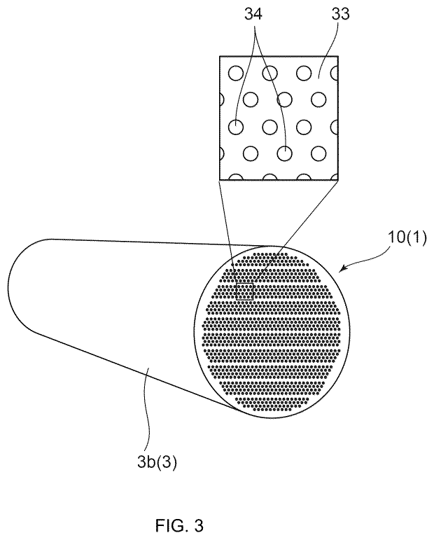

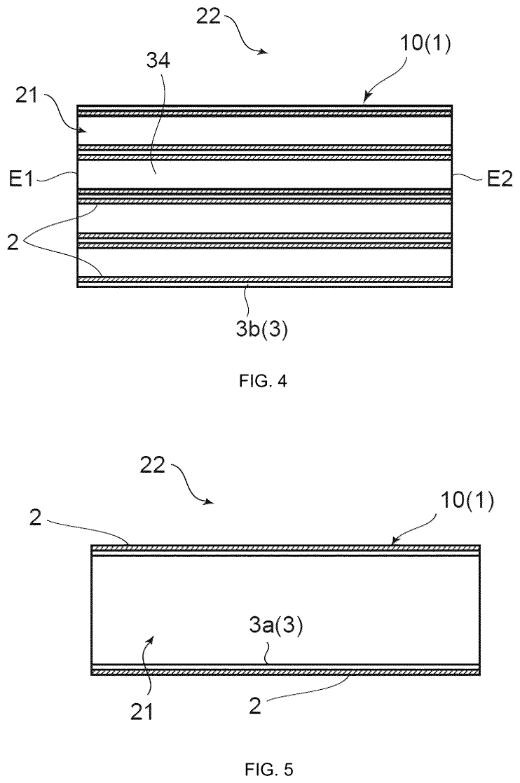

In another embodiment, as illustrated in FIG. 3 and FIG. 4, the substrate 3 is a honeycomb-shaped substrate 3b. The honeycomb-shaped substrate 3b includes a partition wall 33 that defines a plurality of cells 34. The cells 34 are each formed in a cylindrical shape so as to penetrate the honeycomb-shaped substrate 3b in its longitudinal direction.

The cells 34 extend from a first end surface E1 (inflow end surface) to a second end surface E2 (outflow end surface) of the honeycomb-shaped substrate 3b in the longitudinal direction (axial direction) of the honeycomb-shaped substrate 3b (see FIG. 4). The cells 34 each have any appropriate shape in cross section taken in the direction orthogonal to the length direction of the honeycomb-shaped substrate 3b. Examples of the sectional shape of the cell include a triangular shape, a rectangular shape, pentagonal shape, a polygonal shape having six or more sides, a circular shape, and an elliptical shape. The sectional shape and the size of the cell may be the same for all the cells or may be different for at least some of the cells. A preferred one of the above-mentioned sectional shapes of the cell is a circular shape.

The distance between the central axes of the plurality of cells 34 is, for example, from 0.3 mm to 10 mm. A cell density (that is, the number of cells 34 per unit area) in cross section taken in the direction orthogonal to the length direction of the honeycomb-shaped substrate may be appropriately set in accordance with its purpose. The cell density may be, for example, from 4 cells/cm² to 320 cells/cm². When the cell density falls within such a range, sufficient strength and effective geometric surface area (GSA) of the honeycomb-shaped substrate can be ensured.

The honeycomb-shaped substrate 3b has any appropriate shape (overall shape). Examples of the honeycomb-shaped substrate include a columnar shape with a circular bottom surface, an elliptical cylindrical shape with an elliptical bottom surface, a prism shape with a polygonal bottom surface, and a pillar shape with an indefinite bottom surface. The honeycomb-shaped substrate 3b of the illustrated example has a columnar shape. The outer diameter and the length of the honeycomb-shaped substrate may be appropriately set in accordance with its purpose.

In this embodiment, the internal space of each of the plurality of cells 34 (space defined by the inner peripheral surface of the cell) includes any one of the first flow path 21 or the second flow path 22, and the external space of the honeycomb-shaped substrate 3b (space outside the outer peripheral surface of the honeycomb-shaped substrate) includes another one of the first flow path 21 or the second flow path 22. In the illustrated example, the internal space of the cell 34 includes the first flow path 21, and the external space of the honeycomb-shaped substrate 3b includes the second flow path 22.

### B-1-2. Separation Membrane

The separation membrane 2 is typically directly provided on the surface of the substrate 3. The separation membrane 2 may face the first flow path 21 (see FIG. 1 and FIG. 4) or may face the second flow path 22 (see FIG. 5).

In one embodiment, the separation membrane 2 faces the first flow path 21.

In FIG. 1, the substrate 3 is the cylindrical substrate 3a. The separation membrane 2 is formed on the inner surface of the cylindrical substrate 3a. In the illustrated example, the first flow path 21 is defined in a portion (typically, the central portion) of the separation membrane complex 10, in which the separation membrane 2 is absent, in cross section.

Further, in FIG. 4, the substrate 3 is the honeycomb-shaped substrate 3b. The separation membrane 2 is formed on the inner surface of each of the plurality of cells 34. The first flow path 21 is defined in a portion (typically, the central portion) of the cell 34, in which the separation membrane 2 is absent, in cross section.

As in the illustrated example, the separation membrane 2 may be formed entirely on the inner surface of the cylindrical substrate 3a or the inner surface of the cell 34 (that is, so as to surround the first flow path 21) or may be formed partially on the inner surface of the cylindrical substrate 3a or the inner surface of the cell 34. The separation membrane that is formed so as to surround the first flow path can improve separation efficiency.

The separation membrane 2 allows a specific substance to permeate therethrough and be separated from the mixture by making use of, for example, a difference in molecular size and/or a difference in adsorptivity.

The separation membrane 2 may be formed of any appropriate material. A typical example of the material for the separation membrane 2 is an inorganic material. Examples of the inorganic material include zeolite, silica, and carbon. The inorganic materials can be used alone or in combination. The specific heat of the material for forming the separation membrane 2 is, for example, from 450 J/kgK to 900 J/kgK.

When the substance to be separated contains water, a preferred example of the material for the separation membrane 2 is zeolite. In one embodiment, the separation membrane 2 is a zeolite membrane.

The zeolite membrane includes a membrane formed from zeolite on the surface of the substrate. The zeolite membrane may contain two or more kinds of zeolites different from each other in structure or composition.

Examples of the zeolite for forming the zeolite membrane include: zeolite in which an atom (T atom) positioned on the center of an oxygen tetrahedron (TO₄) for forming the zeolite is formed of only Si, or Si and Al; AlPO-type zeolite in which the T atom is formed of Al and P; SAPO-type zeolite in which the T atom is formed of Si, Al, and P; MAPSO-type zeolite in which the T atom is formed of magnesium (Mg), Si, Al, and P; and ZnAPSO-type zeolite in which the T atom is formed of zinc (Zn), Si, Al, and P. Part of the T atom may be substituted with any other element.

Examples of the zeolite include AEI-type, AEN-type, AFN-type, AFV-type, AFX-type, BEA-type, CHA-type, DDR-type, ERI-type, ETL-type, FAU-type (X-type or Y-type), GIS-type, LEV-type, LTA-type, MEL-type, MFI-type, MOR-type, PAU-type, RHO-type, SAT-type, and SOD-type zeolites. Of those zeolites, a LTA-type zeolite is preferred.

The maximum number of ring members of the zeolite is, for example, 12 or less, preferably 10 or less, more preferably 8 or less, and is, for example, 6 or more.

The zeolite film contains SiO₂ and Al₂O₃. The zeolite film may further contain an alkali metal. The alkali metal is, for example, sodium (Na) or potassium (K).

The molar ratio “SiO₂/Al₂O₃” in the zeolite film is, for example, 100 or less, preferably 10 or less, more preferably less than 5. The lower limit of the molar ratio “SiO₂/Al₂O₃” in the zeolite film is typically 2. The molar ratio “SiO₂/Al₂O₃” may be measured by, for example, scanning electron microscopy-energy-dispersive X-ray spectroscopy (SEM-EDX; X-ray accelerating voltage: 10 kV).

The average pore diameter of the separation membrane 2 can be appropriately and suitably selected in accordance with the substance to be separated. The average pore diameter of the separation membrane 2 is, for example, from 0.2 nm to 1 nm, preferably from 0.3 nm to 0.5 nm. A separation membrane 2 having a smaller average pore diameter has higher selectivity. The average pore diameter of the separation membrane 2 is smaller than the average pore diameter of the substrate 3. When the separation membrane 2 is a zeolite membrane, the arithmetic average of the short diameter and long diameter of an n-membered ring pore, where “n” represents the maximum number of members in the ring of the zeolite, is adopted as the average pore diameter. The term “n-membered ring pore” refers to such a pore that the number of oxygen atoms in a portion in which the oxygen atom are bonded to T atoms to form a ring structure is “n”. When the zeolite has a plurality of n-membered ring pores equal to each other in “n”, the arithmetic average of the short diameters and long diameters of all the n-membered ring pores is adopted as the average pore diameter of the zeolite. The average pore diameter of the zeolite membrane is determined by the framework structure of the zeolite and may be obtained from a value disclosed in the “Database of Zeolite Structures” of the International Zeolite Association, [online], from the Internet <URL: http://www.iza-structure. org/databases/>.

The thickness of the separation membrane 2 is, for example, from 0.05 μm to 30 μm, preferably from 0.1 μm to 20 μm, more preferably from 0.5 μm to 10 μm. A thicker separation membrane has higher selectivity. A thinner separation membrane increases a permeation rate.

The surface roughness (Ra) of the separation membrane 2 is, for example, 5 μm or less, preferably 2 μm or less, more preferably 1 μm or less, still more preferably 0.5 μm or less. The surface roughness (Ra) can be measured, for example, in conformity with JIS B 0601.

The separation membrane 2 may be formed by any appropriate method in accordance with a material for forming the membrane. For example, the zeolite membrane may be obtained by: applying zeolite serving as a seed crystal onto a substrate; immersing the substrate to which the seed crystal has adhered in a starting material solution; and growing zeolite from the seed crystal serving as a nucleus through hydrothermal synthesis. The starting material solution contains, for example, a silica source, an alumina source, organic matter, an alkali source, or water. A heating temperature in the hydrothermal synthesis is set to, for example, from 60° C. to 200° C. A heating time is set to, for example, from 1 hour to 240 hours. In addition, the separation membrane may be formed by using a starting material slurry obtained by mixing an organic binder, a ceramic starting material, and a solvent.

### B-2. Other Configurations

The above-mentioned separation device 1 may include any appropriate element in addition to the separation membrane complex 10. The separation device 1 may include, for example: a supply unit for supplying a fluid (a gas supplied at the time of activation, the mixture supplied after the activation) or the like; a heating device for heating the fluid; and a recovery unit for recovering the fluid that has passed through the separation membrane complex. Examples of the heating device include a reactor involving a chemical reaction, a heater, and a heat exchanger. Th separation device 1 may further include a pressure adjustment unit 7 capable of adjusting the pressure in the first flow path 21 and/or the second flow path 22 of the separation membrane complex 10. The separation device 1 may further include a control unit 8 capable of controlling the operation of the separation device 1. Components of the separation device other than the separation membrane complex are described in, for example, WO 2018/225325 A1. The description of this publication is herein incorporated by reference.

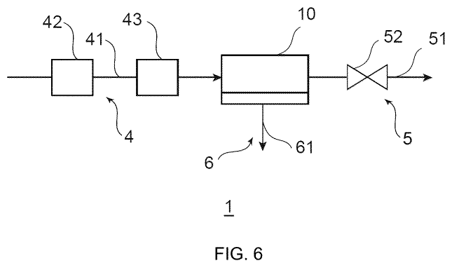

In one embodiment, as illustrated in FIG. 6, the separation device 1 includes, in addition to the separation membrane complex 10: a supply unit 4 that supplies a mixture to the first flow path 21 of the separation membrane complex 10; a first recovery unit 5 that recovers a fluid having passed through the first flow path 21; and a second recovery unit 6 that recovers a permeate substance that has permeated through the separation membrane 2. The separation device 1 of the illustrated example is configured so as to be capable of adjusting the temperature, the pressure, and the flow rate of the mixture passing through the first flow path. FIG. 6 is an explanatory diagram for illustrating one embodiment of the present disclosure, and the present disclosure is not limited to this embodiment.

The supply unit 4 of the illustrated example can adjust the temperature and the flow rate of the mixture supplied to (flowing into) the first flow path 21. The supply unit 4 includes a supply line 41, a heating device 42, and a flow rate adjuster 43.

The supply line 41 is a pipe for supplying the mixture to the first flow path 21. The upstream end portion of the supply line 41 in the direction of supply of the mixture is connected to, for example, a storage tank that stores the mixture, although not shown. The downstream end portion of the supply line 41 in the direction of supply of the mixture is connected to the inflow port of the first flow path 21 of the separation membrane complex 10.

The heating device 42 is provided to the supply line 41 and can heat the mixture passing through the supply line 41. The heating device 42 can have any appropriate configuration.

The flow rate adjuster 43 can adjust the flow rate of the mixture passing through the supply line 41. The flow rate adjuster 43 can have any appropriate configuration. In the illustrated example, the flow rate adjuster 43 is provided between the heating device 42 and the separation membrane complex 10 in the supply line 41.

The supply unit 4 may include other devices as required. For example, other devices may be provided between the flow rate adjuster 43 and the separation membrane complex 10 in the supply line 41.

The first recovery unit 5 of the illustrated example can adjust the pressure in the first flow path 21. The first recovery unit 5 includes a first recovery line 51 and a pressure adjustment valve 52.

The first recovery line 51 is a pipe through which a fluid that has passed through the first flow path 21 of the separation membrane complex 10 is allowed to pass. The upstream end portion of the first recovery line 51 in the direction of passage of the fluid is connected to the outflow port of the first flow path 21 of the separation membrane complex 10. The downstream end portion of the first recovery line 51 in the direction of passage of the fluid is connected to, for example, a storage tank, although not shown.

The pressure adjustment valve 52 is provided to the first recovery line 51. The pressure adjustment valve 52 can adjust the opening degree of the first recovery line 51, and in turn, can adjust the pressure in the first flow path 21.

The second recovery unit 6 of the illustrated example includes a second recovery line 61.

The second recovery line 61 is a pipe through which a fluid that has passed through the second flow path 22 is allowed to pass from the second flow path 22 of the separation membrane complex 10. The upstream end portion of the second recovery line 61 in the direction of passage of the fluid is connected to the outflow port of the second flow path 22 of the separation membrane complex 10. The downstream end portion of the second recovery line 61 in the direction of passage of the fluid is connected to, for example, a storage tank, although not shown.

In the embodiment described above, the supply unit 4 on the upstream side with respect to the separation membrane complex 10 adjusts the temperature and the flow rate of the mixture supplied to (flowing into) the first flow path 21, and the first recovery unit 5 on the downstream side with respect to the separation membrane complex 10 adjusts the pressure on the mixture in the first flow path 21. However, the configuration of the separation device 1 is not limited to that described above. The supply unit 4 may be configured so as to be capable of adjusting the pressure on the mixture in the first flow path 21. Further, the first recovery unit 5 may be configured so as to be capable of adjusting the flow rate of the mixture passing through the first flow path 21.

The transient operation method for a separation device according to the embodiment of the present disclosure is used for the separation of a specific substance in a mixture, in particular, suitably used for the separation of water from a water-containing mixture.

What is claimed is:

1. A transient operation method for a separation device, the separation device including a separation membrane complex including: a separation membrane; and a substrate arranged on one side of the separation membrane, the separation device having a first flow path and a second flow path, the first flow path being positioned on a side closer to the separation membrane of the separation membrane complex, the second flow path being positioned on a side closer to the substrate of the separation membrane complex,
the transient operation method comprising heating the separation membrane complex by supplying a gas at least to the second flow path,
wherein the gas supplied to the second flow path satisfies the following formula (1):
ΔCp₂/ΔT₂<0 (J/(mol·K²)) (1)
where ΔCp₂ represents a difference between a molar specific heat at constant pressure “a” at the separation membrane complex inlet of the second flow path and a molar specific heat at constant pressure “b” at the separation membrane complex outlet of the second flow path (molar specific heat at constant pressure “a”-molar specific heat at constant pressure “b”) (in J/(mol ·K) as unit), and
ΔT₂ represents a difference between a gas temperature “a” at the separation membrane complex inlet of the second flow path and a gas temperature “b” at the separation membrane complex outlet of the second flow path (gas temperature “a”-gas temperature “b”) (in K as unit).

2. A transient operation method for a separation device, the separation device including a separation membrane complex including: a separation membrane; and a substrate arranged on one side of the separation membrane, the separation device having a first flow path and a second flow path, the first flow path being positioned on a side closer to the separation membrane of the separation membrane complex, the second flow path being positioned on a side closer to the substrate of the separation membrane complex,
the transient operation method comprising heating the separation membrane complex by supplying gases to the first flow path and the second flow path, respectively,
wherein ΔCp₂/ΔT₂ of the gas supplied to the second flow path is smaller than ΔCp₁/ΔT₁ of the gas supplied to the first flow path, wherein the ΔCp₁ represents a difference between a molar specific heat at constant pressure “c” at the separation membrane complex inlet of the first flow path and a molar specific heat at constant pressure “d” at the separation membrane complex outlet of the first flow path (molar specific heat at constant pressure “c”-molar specific heat at constant pressure “d”) (in J/(mol ·K) as unit),
wherein the ΔT₁ represents a difference between a gas temperature “c” at the separation membrane complex inlet of the first flow path and a gas temperature “d” at the separation membrane complex outlet of the first flow path (gas temperature “c”-gas temperature “d”) (in K as unit),
wherein the ΔCp₂ represents a difference between a molar specific heat at constant pressure “a” at the separation membrane complex inlet of the second flow path and a molar specific heat at constant pressure “b” at the separation membrane complex outlet of the second flow path (molar specific heat at constant pressure “a”-molar specific heat at constant pressure “b”) (in J/(mol ·K) as unit), and
wherein the ΔT₂ represents a difference between a gas temperature “a” at the separation membrane complex inlet of the second flow path and a gas temperature “b” at the separation membrane complex outlet of the second flow path (gas temperature “a”-gas temperature “b”) (in K as unit).

3. The transient operation method for a separation device according to claim 2, wherein the gas supplied to the second flow path satisfies the following formula (1):
ΔCp₂/ΔT₂<0 (J/(mol·K²)) (1).

4. The transient operation method for a separation device according to claim 1, wherein the gas supplied to the second flow path contains water vapor.

5. The transient operation method for a separation device according to claim 4, wherein a water vapor content of the gas supplied to the second flow path is 10 mol % or more.

6. The transient operation method for a separation device according to claim 1, wherein the gas temperature at the separation membrane complex inlet of the second flow path is 100° C. or higher.

7. The transient operation method for a separation device according to claim 4, wherein the gas temperature at the separation membrane complex inlet of the second flow path is 100° C. or higher.

8. The transient operation method for a separation device according to claim 5, wherein the gas temperature at the separation membrane complex inlet of the second flow path is 100° C. or higher.

9. The transient operation method for a separation device according to claim 1, wherein the separation membrane is a zeolite membrane.

10. The transient operation method for a separation device according to claim 9, wherein the zeolite membrane is made of LTA-type zeolite.

11. The transient operation method according to claim 1, wherein the transient operation method is an activation method.

12. The transient operation method according to claim 1, wherein the transient operation method is a stopping method.
